(19) United States
(12) Patent Application Publication
(10) Pub. No.: US 2006/0093733 A1
(43) Pub. Date: May 4, 2006

(54) Method for manufacturing an electrode plate with improved reliability

(75) Inventors: Biing-Nan Lin, Taichung County (TW); Ming-Chun Hsiao, Hsinchu County (TW); Chun-Tao Lee, Hsinchu City (TW); Wei-Yi Lin, Yunlin County (TW)

Correspondence Address: BRUCE H. TROXELL;SUITE 1404, 5205 LEESBURG PIKE, FALLS CHURCH, VA, 22041, US

(73) Assignee: Industrial Technology Research Institute

(21) Appl. No.: 11/074,633

(22) Filed: Mar. 9, 2005

(30) Foreign Application Priority Data
Oct. 29, 2004 (TW) 93132858

(51) Int. Cl. B05D 5/06; B05D 5/12

(52) U.S. Cl. 427/64

(57) ABSTRACT

A method for manufacturing an electrode plate with improved reliability, comprising: (a) providing a glass substrate; (b) spreading an Indium Tin Oxide (ITO) layer on a specific area of the glass substrate; (c) exposing and developing the ITO layer; and (d) screen printing at least a thick film conductive layer on the ITO layer.

### FIELD OF THE INVENTION

The present invention relates to a method of manufacturing an electrode plate, more particularly to a method of manufacturing an electrode plate by using a process of thick film screen printing.

### BACKGROUND OF THE INVENTION

The luminescence principle of a field emission display is that using an electric field in a vacuum condition to attract out electrons at material tips thus the field emission electrons leaving the cathode plate, being accelerated by a positive voltage on the anode plate and hitting the phosphor powders on the anode plate to emit light, and the electrons received on the electrode plate returning to the circuit via the conductive part of the electrode plate. When the display is required to increase the voltage to produce more electrons to hit the phosphor powders and result in brighter luminescence or when the luminescence area of the display increases, the conductive part which collects electrons flow on the electrode plate can not bear and will break down such that the electrons can not flow into the display and the display will be invalidated. Therefore, the design for an electrode plate regarding whether the display can sustain high electrons flow is an important issue.

In prior arts, the above-mentioned defect was avoided by plating a metal, e.g. chromium, on the sealing part as a conducting layer such that the metal and Indium Tin Oxide (ITO) can conduct voltages into the display. However, the prior arts used a thin film process so that the thickness of the metal layer and the ITO layer is insufficient for high electronics flow and causes the display to break down.

Please refer to FIG. 1 for a prior art electrode plate. A glass substrate 21 of an electrode plate 2 is plated with a conducting layer 25 and a frame pattern is plated on the conducting layer 25 besides the areas of a luminescence material 24. However, the material of the frame pattern is not conductive and the frame pattern is manufactured by a thin film process so that the frame pattern has no effect of reducing current density. The frame pattern is usually black and its main function is to enhance the light contrast, i.e. using the frame pattern as a black background to cause the luminescence material 24 to be clearer. Thus, the conductivity of the conducting layer 25 is still insufficient such that the conducting layer 25 will break down and broken lines 26a and 26b will occur when the current is too large. For example, a 10″ panel will occur broken lines after 1 minute with a conducted voltage of 2500 volts and a maximum current of 20 μA.

In view of the prior art electrode plate, how to improve the electrode reliability of an electrode plate so as to increase the luminescence area of the display has become a problem to be resolved in the industry.

### SUMMARY OF THE INVENTION

The primary objective of the present invention is to provide a method of manufacturing an electrode plate with improved reliability. The method can improve reliability of an electrode plate such that the conductive part of the electrode plate will not break down and surroundings of the luminescence material of the electrode plate will not occur damages or broken lines when high current density is led into the electrode plate.

To achieve the foregoing objective, the method of manufacturing an electrode plate with improved reliability comprises the following steps: (a) providing a glass substrate; (b) spreading an Indium Tin Oxide (ITO) layer on a specific area of the glass substrate; (c) exposing and developing the ITO layer; and (d) spreading at least a thick film conductive layer on the ITO layer. In which, the step of spreading a thick film conductive layer is processed by a thick film screen printing process so that the manufactured thickness of the thick film conductive layer can sustain high current density without damages.

To make the examiner easier to understand the objective, structure, innovative features, and function of the invention, preferred embodiments together with accompanying drawings are illustrated for the detailed description of the invention.

### BRIEF DESCRIPTION OF THE DRAWINGS

FIG. 1 is a top-view diagram of a prior art electrode plate.

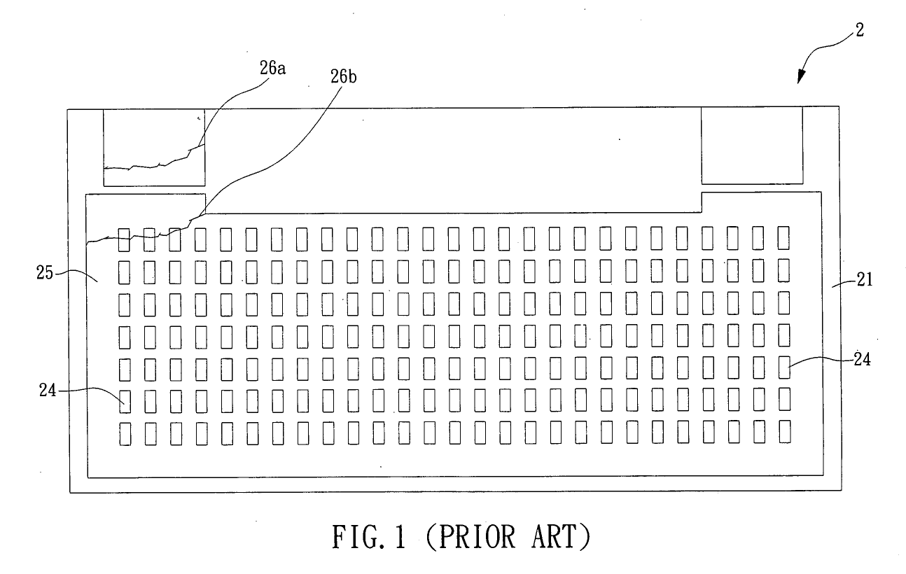

FIG. 2A is a top-view diagram of an electrode plate with improved reliability of the present invention.

FIG. 2B is a cross sectional diagram of an electrode plate with improved reliability of the present invention.

FIG. 3 is a flowing chart of manufacturing an electrode plate with improved reliability of the present invention.

### DESCRIPTION OF THE PREFERRED EMBODIMENT

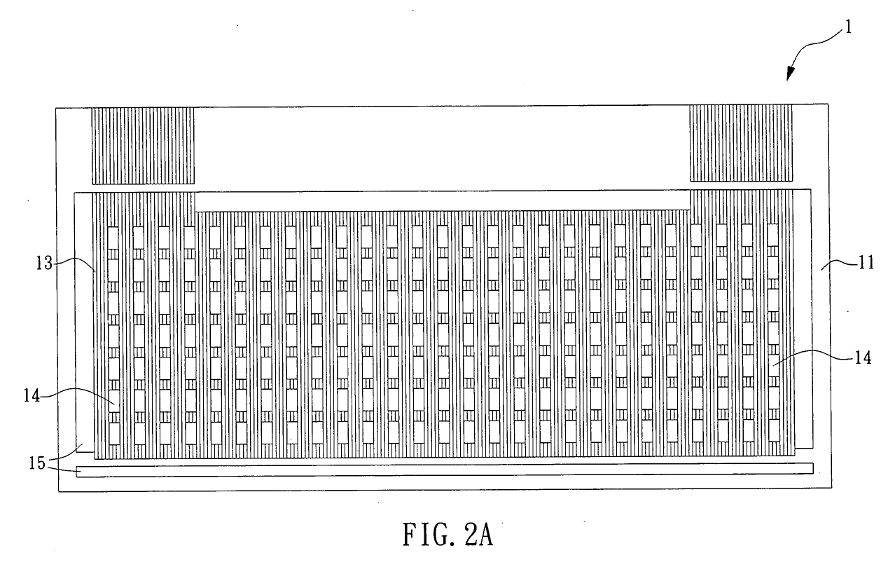

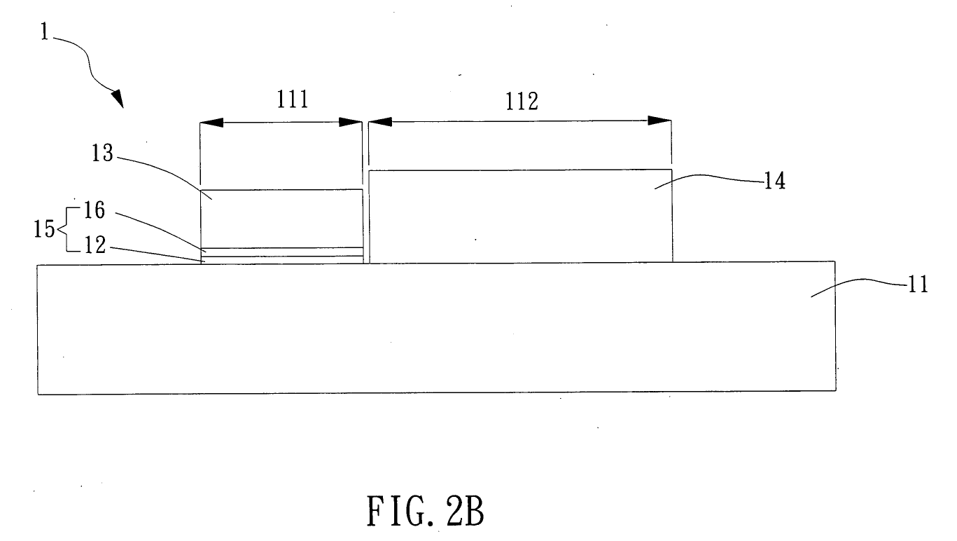

FIG. 2A and FIG. 2B is a top-view diagram and a cross sectional diagram of an electrode plate with improved reliability of the present invention, respectively, wherein the electrode plate 1 is a non-backlight anode plate which comprising a glass substrate 11, an ITO layer 12, a thick film conductive layer 13, a luminescence material 14 and a metal layer 16. The ITO layer 12 is stacked on an area 111 of the glass substrate 11 and the metal layer 16 is stacked on the ITO layer 12. The thick film conductive layer 13 is spread on the metal layer 16 and the luminescence material 14 is stacked on an area 112 of the glass substrate 11, wherein the area 111 and the area 112 are independent and non-overlapped ones. The ITO layer 12 and the metal layer 16 form the conductive layer 15.

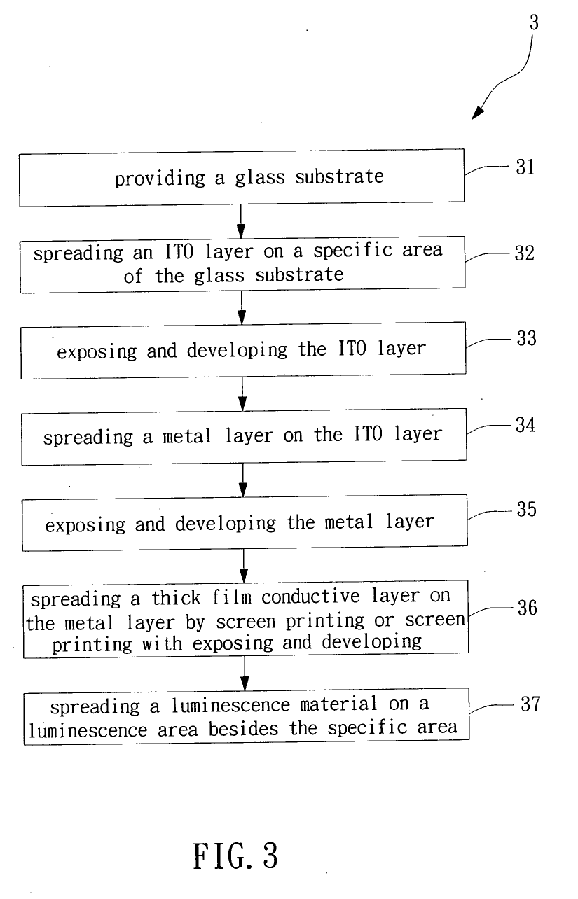

FIG. 3 is a flowing chart of manufacturing an anode plate according to the present invention. The anode plate manufacturing process 3 comprises steps 31-37, wherein step 31 is a step of providing a glass substrate; step 32 is a step of spreading an ITO layer on a specific area of the glass substrate, in which the ITO layer is used as an electrode; step 33 is a step of exposing and developing the ITO layer; step 34 is a step of spreading a metal layer on the ITO layer; step 35 is a step of exposing and developing the metal layer; step 36 is a step of spreading a thick film conductive layer on the metal layer by screen printing or screen printing with exposing and developing; and step 37 is a step of spreading a luminescence material on a luminescence area besides the specific area.

In a preferred embodiment of the present invention, the metal layer is a chromium (Cr) layer which thickness is 400 nm and is manufactured by a thin film process. The thickness of the ITO layer is 400 nm and is also manufactured by the thin film process. The luminescence material is phosphor powders and the screen printed thickness, which is 3-20 μm in general, depends on the size of the phosphor powders and the viscosity of the slurry. The thick film conductive layer is a silver (Ag) layer and is spread on the metal layer by a thick film screen printing process. Therefore, the thickness of the thick film conductive layer is larger than 1 μm thus it can sustain larger current density. Certainly, the thick film conductive layer can be made of any conductive material capable of been used to drive the display and is not limited to metal materials.

In another preferred embodiment of the present invention, the metal layer (Cr) is not required when the electrode plate is used as a backlight anode plate. Therefore, the reliability of the anode plate can be improved by spreading the thick film conductive layer (Ag) on the ITO layer directly. In such situation, the anode plate manufacturing process 3 can omit steps 34 and 35 and the thick film conductive layer is spread on the ITO layer directly in step 36.

When the invention is applied for manufacturing an electrode plate used in a 4″ backlight display panel, in general conditions, the voltage still can be conducted into the panel and the thick film conductive layer (Ag) has no strange change after 10 minutes with a voltage of 1000 volts and a current of 20 μA. In an extreme experiment condition, in which the voltage is 10000 volts and the maximum current is 100 μA, electric arcs will occur and the voltage still can be conducted into the panel after 10 minutes. There is only some burned black made by the electric arcs occurring on the thick film conductive layer (Ag) contacting with the electrode. Therefore, the invention can indeed achieve the effect of improving the reliability of an electrode plate.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for manufacturing an electrode plate with improved reliability, comprising:
(a) providing a glass substrate;
(b) spreading an Indium Tin Oxide (ITO) layer on a specific area of the glass substrate;
(c) exposing and developing the ITO layer; and
(d) screen printing at least a thick film conductive layer on the ITO layer.

2. The method for manufacturing an electrode plate with improved reliability of claim 1, wherein the thick film conductive layer is a metal layer.

3. The method for manufacturing an electrode plate with improved reliability of claim 2, wherein the metal layer is made of silver (Ag).

4. The method for manufacturing an electrode plate with improved reliability of claim 1, wherein the thick film conductive layer comprises at least a first metal layer and a second metal layer, the material of the first metal layer is different from the material of the second metal layer, and the first metal layer is stacked on the second metal layer.

5. The method for manufacturing an electrode plate with improved reliability of claim 4, wherein the first metal layer is made of silver (Ag).

6. The method for manufacturing an electrode plate with improved reliability of claim 4, wherein the second metal layer is made of chromium (Cr).

7. The method for manufacturing an electrode plate with improved reliability of claim 1, wherein there is a luminescence area besides the specific area, and the luminescence area is spread with a luminescence material.

8. The method for manufacturing an electrode plate with improved reliability of claim 7, wherein the luminescence material is phosphor powders.

9. The method for manufacturing an electrode plate with improved reliability of claim 1, wherein the thickness of the thick film conductive layer is larger than 1 μm.
